(19) United States
(12) Patent Application Publication
(10) Pub. No.: US 2019/0250424 A1
(43) Pub. Date: Aug. 15, 2019

(54) Eye wear retainer

(71) Applicant: Peter Kahn, Westhampton, NY (US)

(72) Inventor: Peter Kahn, Westhampton, NY (US)

(73) Assignee: Peter Kahn, Westhampton, NY (US)

(21) Appl. No.: 15/932,149

(22) Filed: Feb. 13, 2018

(51) Int. Cl. G02C 3/00

(52) U.S. Cl. CPC G02C 3/006; B65H 75/4428; G02C 3/003

(57) ABSTRACT

An eye wear retainer is disclosed which can be adjusted such that it can be raised or lowered without pre-set braking points. The braking mechanism is automatic or self-adjusting, and does not require a button or switch for use. The wearer using the eye wear retainer merely raises or lowers the eyeglasses or sunglasses to the desired height on his or her body, with the only limitation being the length of the wire connecting the eyeglasses to the eye wear retainer device.

An eye wear retainer is disclosed which allows for adjustable recoiling of the cable or wire attached to the eyeglasses.

### BRIEF DESCRIPTION OF THE FIGURES

The figures depict various embodiments of the described methods and system and are for purposes of illustration only. One skilled in the art will readily recognize from the following discussion that alternative embodiments of the methods and systems illustrated herein may be employed without departing from the principles of the methods and systems described herein.

FIG. 1 is a perspective view of one embodiment of the eye wear retainer shown in use;

FIG. 2 is an exploded view of the eye wear retainer;

FIG. 3 is a rear perspective view of the eye wear retainer;

FIG. 4 an exploded view of the central section of the eye wear retainer;

FIG. 5 is a view front view of the casing of the eye wear retainer;

FIG. 6 is a side view of the eye wear retainer;

FIG. 7 is a side view of the casing of the eye wear retainer;

FIG. 8 is a cross sectional side view of the casing of the eye wear retainer;

FIG. 9 is a rear perspective view of another embodiment of the eye wear retainer;

FIG. 10 is a side view of the attachment of the alternative embodiment attached to a pair of glasses;

FIG. 11 is a perspective see through view of the attachment mechanisms of the alternative embodiment of the eye wear retainer;

FIG. 12 is a perspective view of the eye glass frame plug;

FIG. 13 is a front angular perspective view of a person wearing glasses attached to the eye wear retainer on their upper chest;

FIG. 14 is a front angular perspective view of a person wearing the glasses attached to their eye wear retainer lower down than the person in FIG. 13;

FIG. 15 is a front angular perspective view of a person wearing their glasses attached to the eye wear retainer on their nose;

FIG. 16 is a back perspective view of a person wearing the eye wear retainer which is attached to glasses;

FIG. 17 is an overhead view of the enclosed case with a jack positioned at each end;

FIG. 18 is cross section of a cable;

FIG. 19 is a perspective view of the plug with a ferromagnetic insert and a sleeve with a ferromagnetic insert; and

FIG. 20 is a perspective view of another means of attaching the cable to the eye wear;

FIG. 21 is side cutaway view of another embodiment of the plug;

FIG. 22 is a side cutaway view of yet another embodiment of the plug; and

FIG. 23 is a cross section of the sleeve.

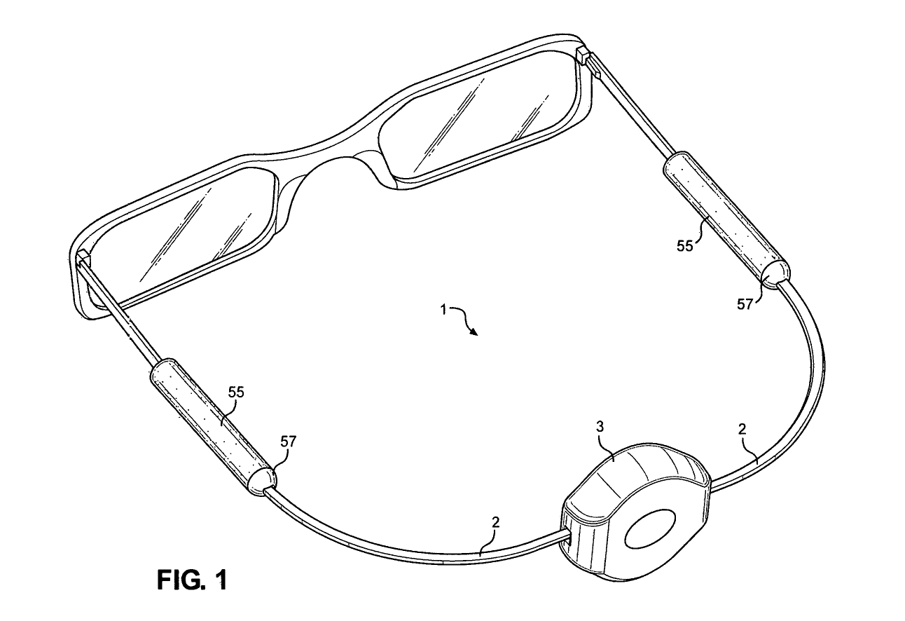

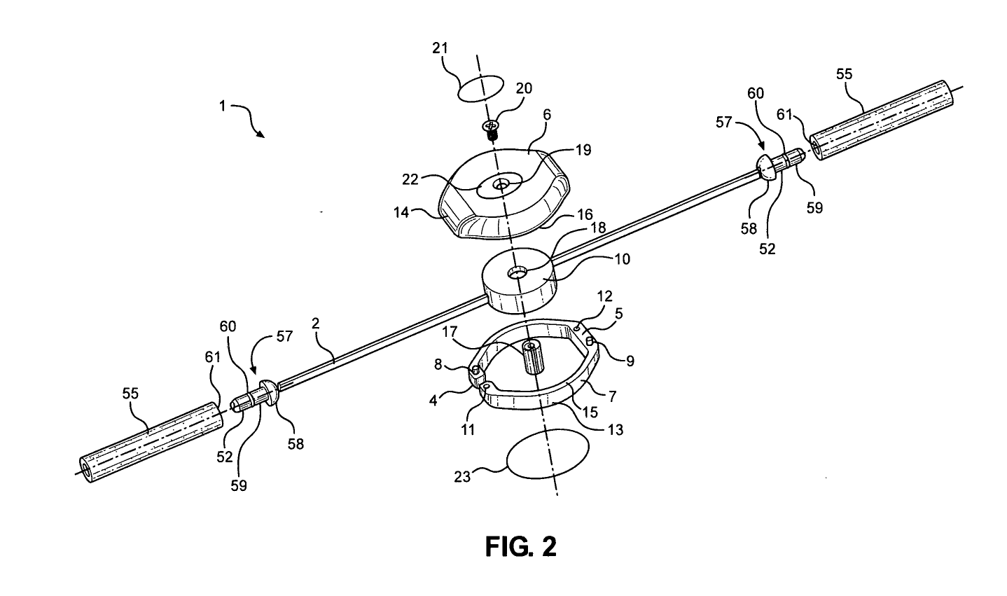

### DETAILED DESCRIPTION OF THE DISCLOSURE

The eye wear retainer 1 allows for the positioning of eyewear, such as glasses, anywhere on a person, limited only by the length of the cable, wire, or string 2. For the purposes of verbal simplicity, the term wire or cable as used in this disclosure shall refer to any elongated flexible material such as cables, strings, threads, metal wire, plastic enbodyd metal wires, strings, chains, or any other similar structure. Using the eye glass retainer 1, eyeglasses can be worn around the neck, reside on a user's chest, or on their stomach. In one embodiment, the eye wear retainer 1 has no set stops but rather permits the user to set the heights of the eyeglasses wherever he or she desires. In another embodiment, there are set stops. In yet another embodiment, the reel does have set stops, but the weight of the glasses moves the glasses past the set stops, essentially creating an unlimited number of stops.

In one embodiment, the wire or cable 2 is flat for easier spooling and for comfort against the user's head, especially around the ears. In another embodiment, the flat wire is split down the middle. Specifically, the split flat wire 300 has two wires 301, 302 surrounded by flat plastic 303, further preventing entanglement and discomfort.

The eye wear retainer 1, in addition to the cable 2, contains a body 3. In one embodiment, the body 3 lessens the chance that a user's hair will get getting tangled up in the spring loaded reel 10, due to the reduced exposure of hair to the movable parts of the reel 10. In one embodiment, the body 3 has a top section 6 and a bottom section 7. In another embodiment, both the top section 6 and the bottom section 7 have a curved out edge 13, 14. In another embodiment the top section 6 and the bottom section Tare fitted together with each other and held together by at least two sets of pins 8,9 and two inserts 11, 12 on the edge of the rim 15 of the bottom section 7 of the body as well as their unseen counterpart on the rim 16 of top section 6. In another embodiment, the two sections are glued together. In another embodiment, where glue is used, no pins and inserts are used. In yet another embodiment, the top section 6 and the bottom section 7 are screwed together, with the inserts being threaded, and the pins being the screws, with the heads of the screws protruding through the sections. In yet another embodiment, there are any number of combinations of these connecting means.

The body 3 has two cut through openings 4, 5 on opposing sides of the body 3. In one embodiment, the cut through openings 4,5 are only in the bottom section 7. In another embodiment, the cut through openings span 4, 5 across both the top 6 section and the bottom section 7 of the body 3.

In yet another embodiment, the cut through openings are found in one end of the top section 6, and the other end of the bottom section 7. To further prevent hair entanglement from the reel 10, body 3 is elongated, such that the openings 4, 5, of the body are farther away from the reel 10 than sides 15, 16. In one embodiment, the body 3 has a roughly oblong shape. In another one embodiment, the openings 4, 5 are positioned anywhere from about 2 mm to 10 mm between the openings 4,5 and the outside of reel 10.

In yet another embodiment of the disclosure, there is a spindle 17 affixed to the bottom section 7. In one embodiment, the spindle 17 is integrally molded with the bottom section. The reel 10 has a hollow center 18. The top section 6 has a centered threaded hole 19. After the cable 2 has been extended through openings 4 and 5, and secured so that it does not retract into the reel 10, a screw 20 is threaded through the top section 6, into the spindle 17 and tightened. In another embodiment, a plate 21 fits within a counterpart groove 22, thus covering the screw 20. Similarly, a plate 23 fits within a groove (unshown) in the bottom section 7.

In one embodiment, the reel 10 is an automated stoppable on demand reel 10. This means that the user of the eye wear retainer can position the eyewear anywhere along his body (to the length of the cable 2) without needing to press a release or brake button and without having pre-set stopping positions. The reel or wire reel device features simultaneous, bi-directional wire roll-up/withdrawal. The wire reel device 10 has a resilient positioning function that allows a wire to be wound up and stored in the wire reel device in an organized and managed manner, which ensures optimum and dynamic adjustment of the wire or cable 2 in respect of length control and length management.

In another embodiment, the reel 10 may have a plurality of stops; however, in another embodiment, and depending on the tension of the wire, those stops may be negated by the weight of the glasses and the assembly, actually giving the device an unlimited number of stops.

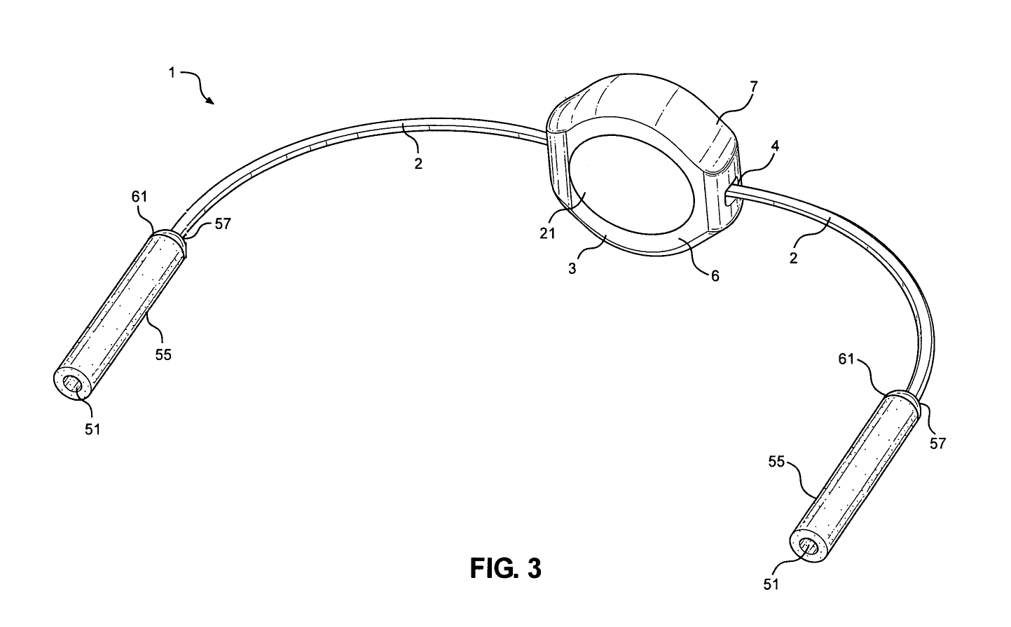

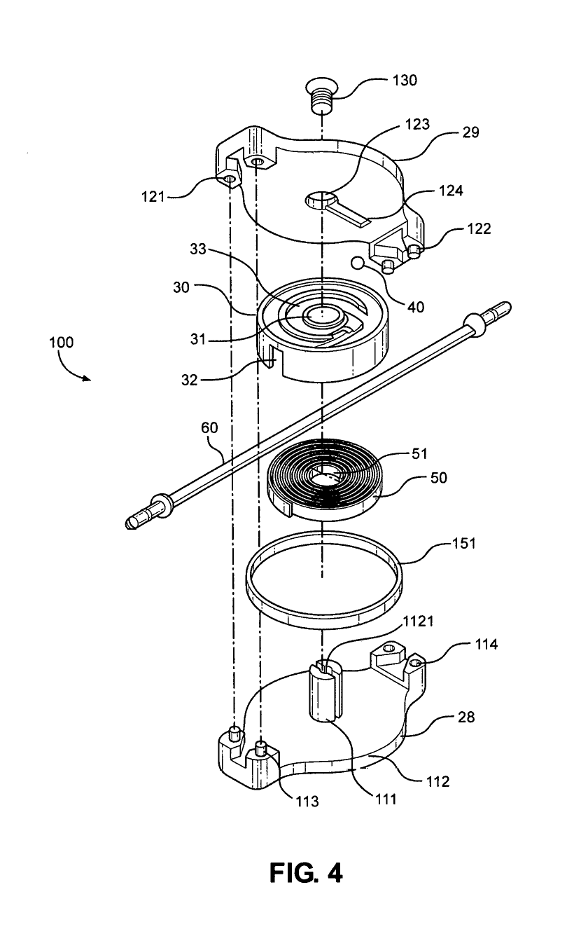

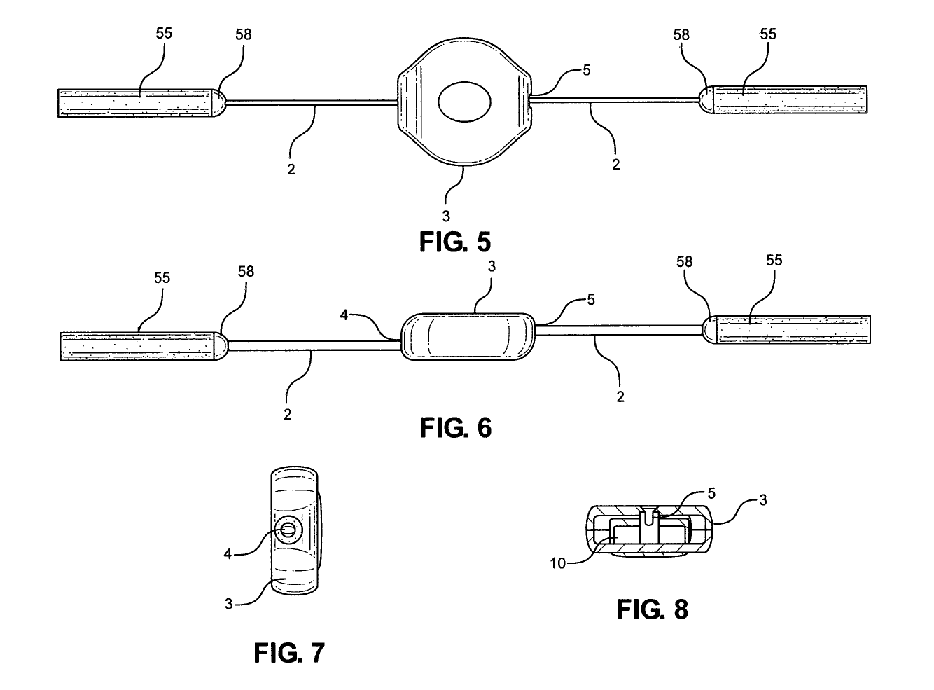

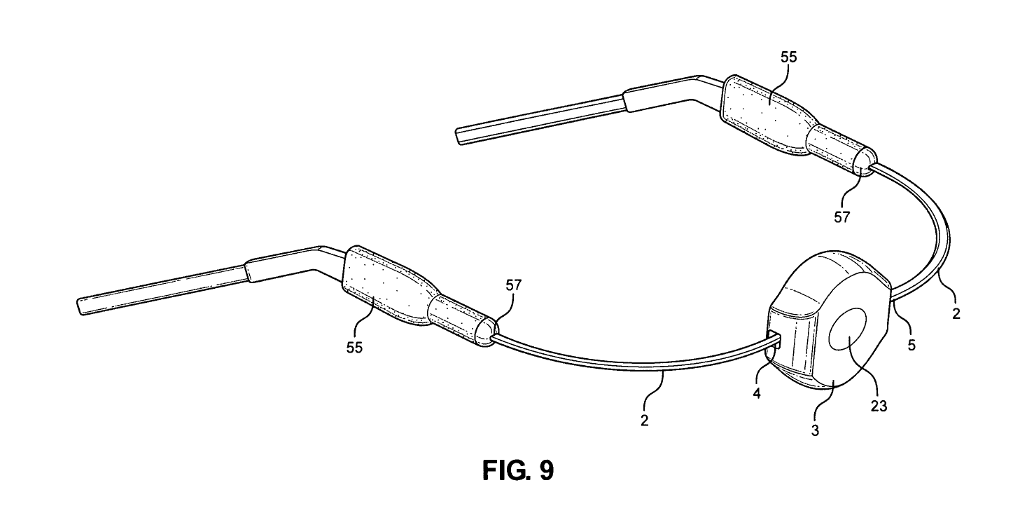

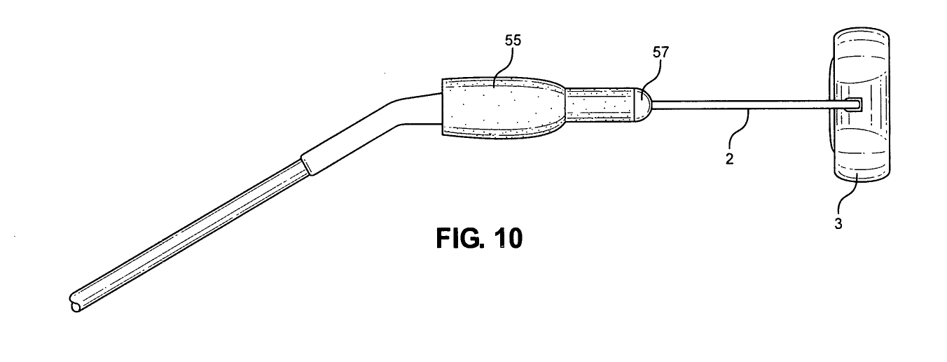

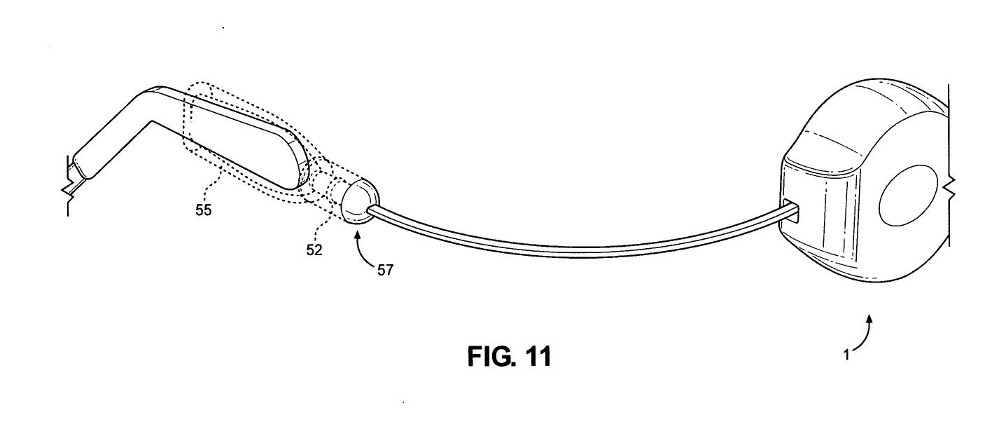

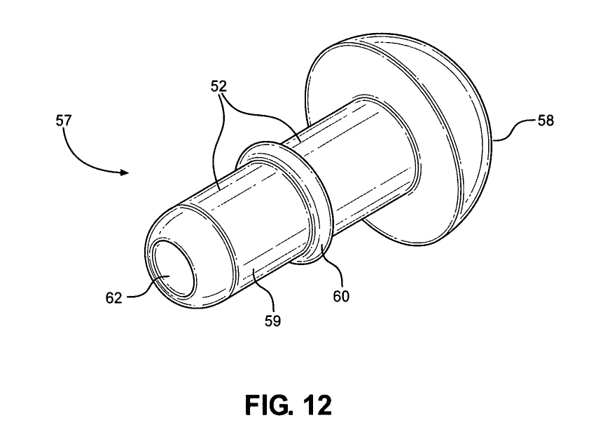

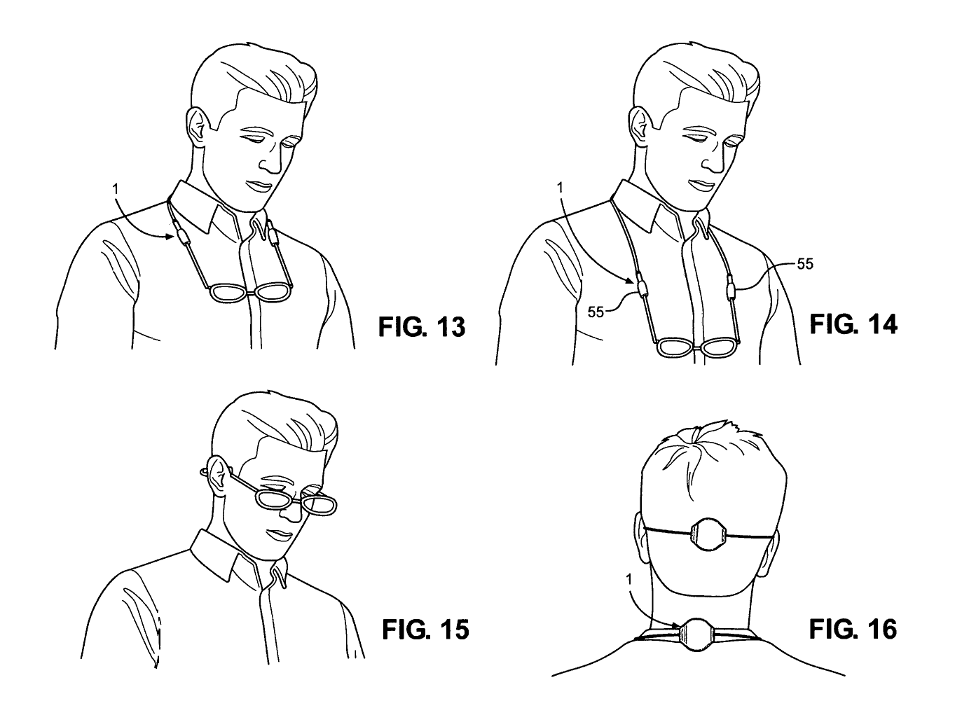

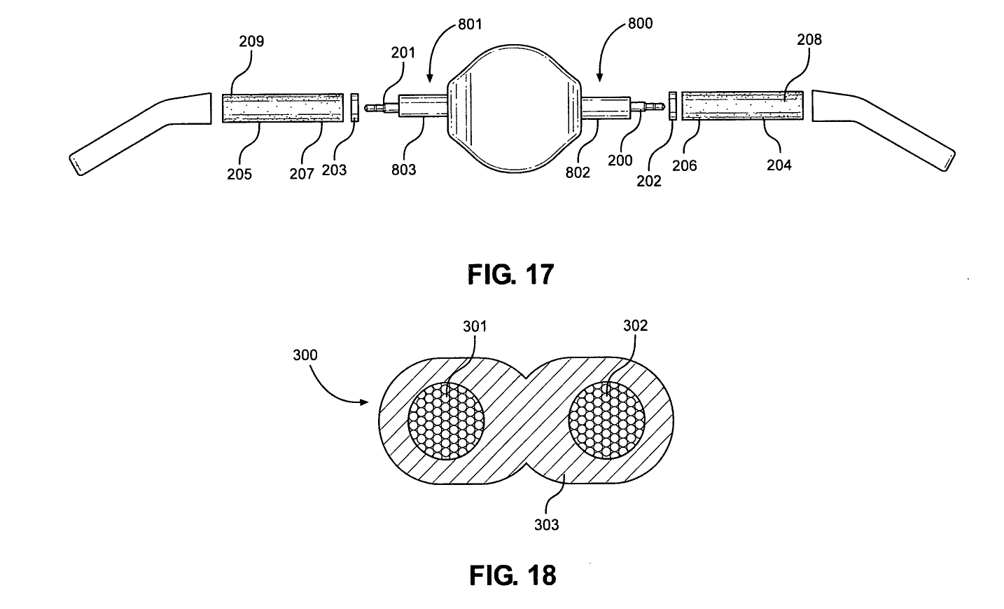

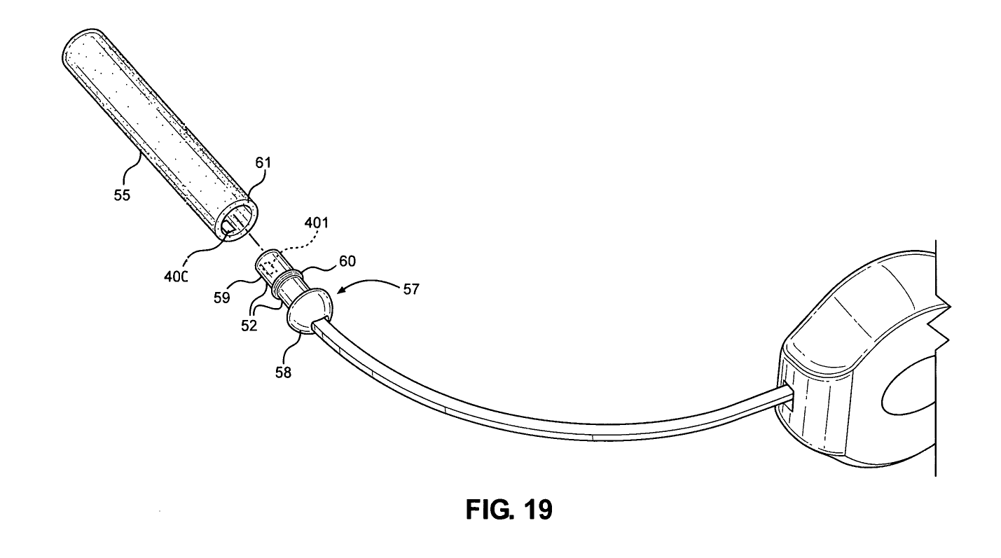

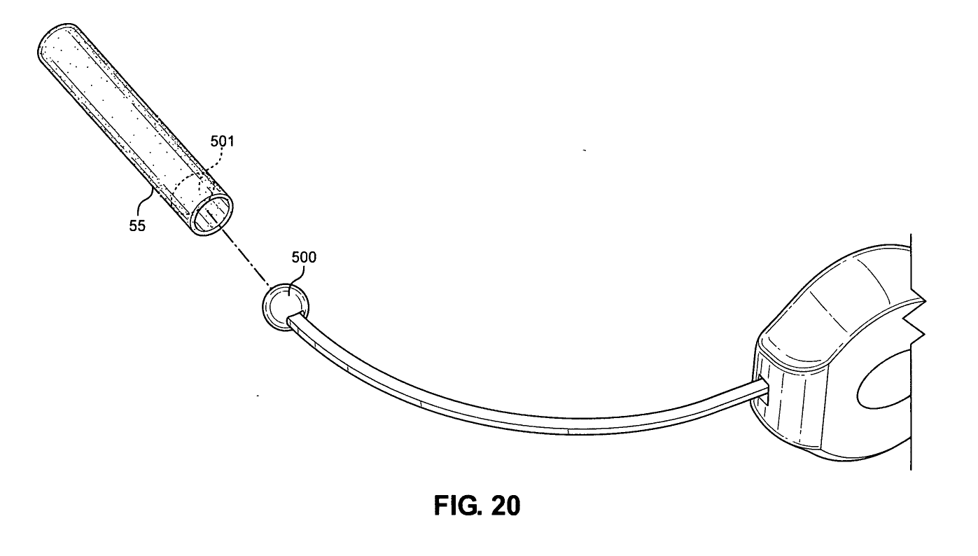

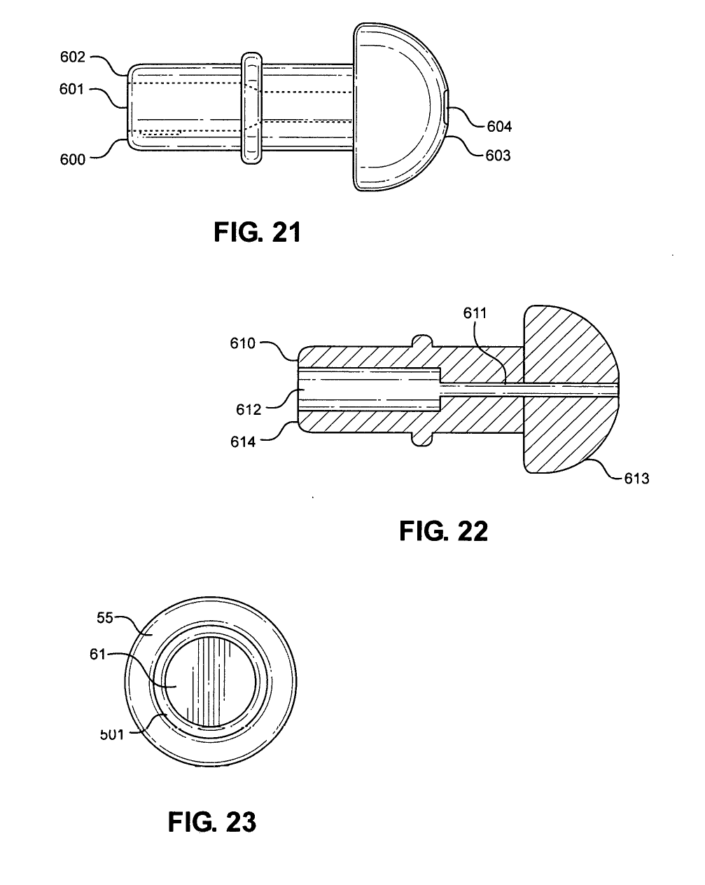

In one embodiment, Japanese Utility Model Registration No. 3093430 (incorporated herein in its entirety) discloses a cable coiler as shown in FIG. 3. This device has a plurality of stops. The aforementioned patent related to a cable coiler having a hanging device or an electric connector 120 at both ends of the cable, and the cable coiler 100 is comprised of a first cover 28 and a second cover 29 coupled with each other, although in the present disclosure, a different wire and end units are used. Convex columns 113, 122 couples with said concave tank or holes 121, 114.

An axle pole 111 projects outward from the center of the first cover, and contains the section tub 112 which penetrates inside for axle pole 111. Screw hole 1121 is installed in this section tub 112.

A punch hole 123 is installed on the second outer cover 29, through which a threaded fastener 130 (e.g. a screw) is inserted, allowing for a secure attachment through the screw hole 1121 of the first outer cover 28 to the second outer cover 29.

Further, the cover 28 comprises or has residing on it a retaining base 151 coupled to the periphery of the axle pole 111, and the retaining base 151 circumscribes a turntable 30 installed onto the axle pole 111. The turntable 30 comprises a positioning hole 31 pivotally coupled onto the axle pole 111 of the first outer cover 28, at least one cable groove 32 disposed on the periphery of the turntable 30, a groove 33 disposed around the surface of the turntable 30, an inclined guide groove 34 and an arc indented groove 35 are disposed proximate to the groove 33.

Further, the turntable 30 itself comprises or circumscribes a volute spring 50 therein and the volute spring 50 comprises a latch end 51 at the inner side of the volute spring 50, and the latch end 51 is coupled onto the open groove 112 of the axle pole 111 of the first outer cover 28.

Continuing, the turntable 30 has a cable or wire 2 at its periphery, and the cable or wire 2 is passed all the way into the cable groove 32 of the turntable 30, such that both ends of the cable 2 can be pulled out. A retaining base 70 is disposed on both ends of the cable 2.

A stop groove 124 is disposed on the underside of the second (or upper) outer cover 29 and a ball bearing 40 is dispensed on the surface of the turntable 30 such that when the first outer cover 28 and second outer cover 29 are attached the ball bearing 40 will be located exactly in the groove 112 of the first outer cover 28 at a position corresponding to the stop groove of the second outer cover 29. A threaded screw goes through the top section 6, through the hole 18 in the reel and through threaded spindle 17.

The eye wear retainer 1 must securely attach to the eye wear so that the eye wear does not accidentally fall off of the user. In one embodiment, the eye wear retainer 1 comprises tubes or sleeves 55 which comprise a hollow sleeve or tube into which a plug 57 connected to the cable or cable is attached. In one embodiment, the plugs 57 are integrally positioned at the distal end of the sleeve or tube 55. The plug 57 fits in through an opening 61 at the distal end of the tube 55. The plug 57 itself has a head 58, a peg 59, and a friction ring 60 which helps secure the plug 57 in place in the opening 61 in the tube 55. A hollow narrow opening 62 extends the length of the plug, 57 with openings at the proximal end of the peg 59, and an opening in the head 58. In this embodiment, glue may not be necessary to secure the wire or cable 2. In one embodiment, the wire or cable 2 could be inserted through the plug 57, folded back over the outside of part of the plug, and inserted into the tube 55, securely held in place by the friction ring 60, positioned midway on the stem 52 of the plug 57. The sleeves 55 are flexible, have memory, and can be made out of latex, styrofoam, silicon, plastics besides Styrofoam, and other similar materials.

In another embodiment, plug 600 has an opening or hole 601 that tapers/narrows as it goes from the proximal end 602 to the distal end 603. In one embodiment, a cable 2 is threaded out through the opening 604 at the distal end 603 through the opening 601 at the proximal end 602. Using pliers, the cable 2 can be knotted or doubled over on itself, so that it is too thick to pass through the tapered distal end of the plug 600.

In another embodiment, a plug 610 has two holes (or passageways) that meet. The hole 611 at the distal end of the plug is narrower than the hole or passageway 612 that begins at the proximal end of the plug. As above, a cable is pulled through the distal end 613 and out the proximal end 614 and crimped so that it cannot be pulled back out through the hole or passageway 611.

It should be noted that the cable 2 can be crimped, knotted, or even glued to prevent it from slipping back out through the distal end of any version of the plug.

To attach the wire or cable 2 to the glasses, the wire or cable 2 is threaded through the narrow opening 62 of the head 58 of the plug 57 and out through the peg 59. The wire 2 is pulled through the opening 62 and folded over the friction ring 60, or merely folded over the side before the friction ring 60. The plug 57 is then pushed into the hollow tube 55. The tubes 55 are fitted over each of the temple tips of the eyeglasses or sunglasses, and the height of the glass wear can then be adjusted to the user's desire.

In yet another embodiment, the cover or handle 802, 803 of a jack 800, 801 is attached to an end of the wire or cable 2 on either side of the body 3 by any means, including glue, over the cover, under the cover, etc. A grip ring 202, 203 fits securely over each of the contact probes 200, 201. The jack-grip ring combination is then inserted into the tube 55 wherein the grip rings 202, 203 help wedge and secure the jacks into the distal ends 206, 207 of the tubes, which are attached to the temple arms at their proximal ends 208, 209. The grip rings 202, 203 fit securely over said contact probes. The grip rings 202, 203 are as wide, or slightly wider than the opening of the tubes 55.

In another embodiment, the plug 57 and the tube 55 are held together by magnets. As shown in FIG. 18, in one embodiment there is there is at least one ferromagnetic structure 400 embedded within the opening 62 of plug 57, which, when inserted into the tube 55, is attracted to another at least one ferromagnetic structure 401, positioned opposite the first ferromagnetic structure 400 when the plug is inserted into the tube 55. In one embodiment, the plug 57 should be inserted all the way into the tube 55 for the ferromagnetic structures 400, 401 to match up. In other words, in one embodiment, the ferromagnetic structures 400, 401 are aligned when the plug 57 is inserted as far as it will go. In another embodiment, both ferromagnetic structures 400, 401 are positioned anywhere along the length of opening 61 and opening 62, as long as they the ferromagnetic structures 400, 401 can align.

In another embodiment, there can be a plurality of ferromagnetic structures in plug 57 that match up with a plurality of ferromagnetic structures in tube 55. The term ferromagnetic structures as used here refers to magnets and the materials to which magnets are attracted. In all situations described, a magnet is present that is attracted to certain types of metals and either the plug 57 or the tube 55 can have the embedded magnets, while the other component has the specific metals to which the magnet is attracted. Alternatively, there can be a mix of magnets and metals in both the plug 57 and the tube 55 as long as they are properly paired.

In another embodiment, the entire plug 57 can be a ferromagnetic material, with the magnet or other ferromagnetic material inside of the tube 55. In yet another embodiment, a ferromagnetic material 615 may line the hole of the tube 55.

In yet another embodiment, a small ball or poppy bead 500 is attached to the end of the wire 2. This poppy bead 500 may or may not have elasticity. It may be made out of virtually any material. Within the tube 55 is a hollow ring 501. This ring may be flexible if the ball is not, but it has enough rigidity to hold the ball 500 once the ball 500 has been pushed past the hollow ring 501. The small ball 500, which in one embodiment is no smaller than opening 6 of the tube 55 can be attached to the wire or cable 2 by any means known in the art, including molding the ball 500 around the end of the wire or cable 2. The hollow ring 501 could be made of rubber, Styrofoam, any other plastic or even metal, as long as it stays positioned and in one embodiment, slightly embedded in the tube 55 and is flexible enough for the ball to squeeze 500 through. The hollow ring 501 fits securely in the tube 55 and can be as wide as or slightly wider than the diameter of the hole of the tube 55. The hollow ring 501 can also be held in place by an adhesive such as glue.

In all embodiments described, glue can be used to further assist the permanent fixture of the cable 2 to the tube or sleeve 55.

Although the present disclosure has been described with reference to the preferred embodiment be made without departing from the scope of the present disclosure which is intended to be defined by the appended claims differing from the type described above.

What we claim is:

1) (canceled)

2) The eye wear retainer of claim 12, wherein said body comprises:
a) a top section; and
b) a bottom section, wherein both sections are combined with the reel positioned positioned in the bottom section.

3) The eye wear retainer of claim 12, where a center of the reel comprises a hole.
a) The eye wear retainer of claim 2, wherein said body further comprises a spindle extending from the center of said bottom section, wherein said spring load reel fits upon the hole in the center of the reel.

4) The eye wear retainer of claim 12, further comprising:
a) a first groove in the outer surface of the top section;
b) a second groove in the outer surface of the bottom section;
c) a first plate which fits within the groove of the top section; and
d) a second plate which fits within the groove of the bottom section.

5) The eye wear retainer of claim 4, further comprising a screw which fits through a threaded hole in the top section, and into the spindle of the bottom section.

6) (canceled)

7) (canceled)

8) (canceled)

9) (canceled)

10) (canceled)

11) (canceled)

12) An eye wear retainer, said eye wear retainer comprising:
a) at least one cable, said at least one cable comprising;
iii) a first end; and
iv) a second end;
b) a spring loaded reel, said reel being automated and stoppable on demand, said spring loaded reel comprising:
iii) a spring;
iv) a roll up disk, said roll up disk containing the at least one cable, said at least one cable positioned on said roll up disk so that both ends of the at least one cable are prominent;
a) a body, said body comprising:
v) a top section;
a bottom section;
vi) a first cut through opening through which said first end said at least one cable fits; and
vii) a second cut through opening through which said second end of said at one cable fits;
b) a first jack, said first jack comprising:
i) a first cover; and
ii) a first contact probe;
c) a second jack, said second jack comprising:
i) a second cover;
ii) a second contact probe;
d) a first grip ring fitted over said first contact probe;
e) a second grip ring fitted over said second contact probe;
f) a first sleeve comprising:
iii) a first proximal end comprising an opening into which a first temple tip is fitted; and
iv) a first distal end into which is fitted a first grip ring fitted on said first contact probe;
g) a second sleeve connected to said second end of said at least one cable, said second sleeve comprising:
iii) a second proximal end comprising an opening into which a second temple tip is fitted; and
iv) a second distal end into which is fitted a second grip ring fitted on said second contact probe.

13) (canceled)
